(19) United States
(12) Patent Application Publication
(10) Pub. No.: US 2015/0237895 A1
(43) Pub. Date: Aug. 27, 2015

(54) Method of Making an Edible Paper-Like Sheet

(71) Applicant: Robert Shay, Warfordsburg, PA (US)

(72) Inventor: Robert Shay, Warfordsburg, PA (US)

(21) Appl. No.: 14/627,519

(22) Filed: Feb. 20, 2015

Related U.S. Application Data
(60) Provisional application No. 61/942,803, filed on Feb. 21, 2014.

(51) Int. Cl. A23L 1/20

(52) U.S. Cl. CPC A23L 1/2005; A23V 2002/00

(57) ABSTRACT

The present invention is directed to an edible paper-like sheet material made from a raw material, including but is not limited to vegetable and roots.

### CROSS-REFERENCE TO RELATED APPLICATIONS

This application claims priority to U.S. Provisional Application Ser. No. 61/942,803, filed Feb. 21, 2014, the content of which is incorporated by reference herein in its entirety.

### BACKGROUND OF THE INVENTION

There is a need for a wide range of convenient, nutritious, tasty foods, including handheld foods and snack foods. A convenient way to present such foodstuffs is as a wrapped food. Examples of wrapped foods are Japanese temaki sushi (hand roll and cone) and onigiri/omusubi (rice ball). Presently the primary sheet product used to wrap sushi and onigiri/omusubi is “nori,” an algae-based food made of seaweed of the genus Porphyra which has been processed and dried into sheets. This product is prepared by a process similar to making paper. An important unique characteristic of seaweed nori sheets is the ability to cleanly fracture on a crease when folded. This property in combination with the properties of high strength-to-weight ratio and high strength at low moisture make it possible to form thin sheets useful to wrap around foods.

With growing consumer demands for foods with improved nutritional value, there is a need for a wide range of convenient, nutritious, tasty food wraps incuding edible paper (e.g., rice paper and nori). The present invention serves to address this need.

### SUMMARY OF THE INVENTION

In one embodiment, the invention provides a method for making an edible paper-like sheet. In one embodiment, the method comprises (a) incubating an edible starting material with a mixture comprising water, salt, and whey for a period of time to generate an edible solution; (b) processing the edible solution to generate a casting solution; (c) applying the casting solution to a container to produce a sheet; (d) drying the sheet to produce an edible paper-like sheet.

In one embodiment, the edible starting material is selection from the group consisting of a vegetable, a root, and any combination thereof.

In one embodiment, the vegetable is selected from the group consisting of green vegetable, swiss chard, kale, collards, carrot, tomato, broccoli, bell pepper, pumpkin, pumpkin, squash, corn, sweet potato, spinach, green bean, green pea, asparagus, alfalfa, and any combination thereof.

In one embodiment, the root is selected from the group consisting of taro, turnip, beets, kolrobi, radish, celery root, and the like.

In one embodiment, the period of time is about 1-5 days.

In one embodiment, the period of time is less than about 1 day.

In one embodiment, the edible starting material is incubated with a mixture comprising water, salt, and whey at a temperature of about 65 degrees Fahrenheit.

In one embodiment, the edible starting material is incubated with a mixture comprising water and salt at a temperature of about 65 degrees Fahrenheit.

In one embodiment, the invention provides an edible paper-like sheet produced by the method of the invention.

In one embodiment, the edible paper-like sheet has a thinkness of about 0.004 to 0.025 of an inch.

### BRIEF DESCRIPTION OF THE DRAWINGS

The following detailed description of preferred embodiments of the invention will be better understood when read in conjunction with the appended drawings. For the purpose of illustrating the invention, there are shown in the drawings embodiments which are presently preferred. It should be understood, however, that the invention is not limited to the precise arrangements and instrumentalities of the embodiments shown in the drawings.

FIG. 1 is a picture of a representative vegetable (e.g., Kale or greens) after being bathe.

FIG. 2 is a picture of grounded up greens or vegetables. One method of grinding up the greens or vegetables is to run the greens or vegetables in a blender.

FIG. 3 is a picture showing half a cup of pure grounded up greens or vegetables.

FIG. 4 is a picture of a half cup of pure grounded up greens or vegetables placed on a screen for draining purposes.

FIG. 5 is a picture of execss liquid being pressed out from the pure grounded up greens or vegetables on a screen.

FIG. 6 is a picture showing that the screen is turned over and the formation of the vegetable paper.

FIG. 7 is a picture of the vegetable pulp prior to drying.

FIG. 8 is a picture showing the addition of spices to the vegetable paper.

FIG. 9 is a picture showing that the pulp is layed out to make a sheet of paper.

FIG. 10 is a picture showing that the pulp is being placed into the dryer.

FIG. 11 is a picture showing the product fully dried final product.

### DETAILED DESCRIPTION

The present invention is broadly directed to an edible paper-like sheet material. In one embodiment, the edible sheet is made from an edible material including but is not limited to vegetable, root, and the like. In a preferred embodiment, the vegetable is kale. In one embodiment, the edible paper-like sheet maintains most of the color and nutritional value of the starting edible material.

The invention also includes the method of making the edible paper-like sheet. In one embodiment, the method of making the edible sheet comprises sealing in the color and nutritional value of the starting edible material. In one embodiment, the method includes incubating the edible starting material with a mixture comprising salt and whey for a period of time in order to generate a solution. The solution is then processed into a slurry. The slurry can be placed on a drainage board to form a sheet where excess liquid is removed from the slurry to produce the edible paper-like sheet.

In one embodiment, the present invention is directed to an edible paper-like sheet made from vegetable, root, or a combination thereof, which has the thinness, strength, flexibility, and texture to serve as alternates or substitutes for a flatbread, seaweed-based paper, rice paper, and the like while providing the nutrition of one or more of vegetables, and roots. The edible paper-like sheet is useful for among other things wrapping around a multiplicity of foods, and can be used to provide wrapped foods.

In another embodiment, the edible paper-like sheet can be eaten as a paper. In one embodiment, each sheet could contain a daily serving of vegetable.

### DEFINITIONS

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About,” as used herein when referring to a measurable value such as an amount, a temporal duration, and the like, is meant to encompass variations of ±20%, ±10%, ±5%, ±1%, or ±0.1% from the specified value, as such variations are appropriate to perform the disclosed methods.

As used herein, “puree” is meant to refer to both heat and non-heat treated whole vegetable and/or pieces which have been mechanically transformed, such as under a screening or pulping device, into viscous slurries. Thus, this comminuted vegetable and/or root material can be distinguished from individual discrete pieces of intact vegetable and/or root flesh.

As used herein, “whey proteins” relate to the proteins contained in a dairy liquid obtained as a supernatant of the curds when milk or a product containing milk components is curded to produce a semisolid cheese curd. Typical ratio of whey protein to casein in a milk system is at about 20 to 80 (20% of proteins in the milk are whey proteins). Whey proteins are highly hydrophilic global proteins.

Ranges: throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### DESCRIPTION

The present invention is broadly directed to an edible paper-like sheet material. The edible paper-like sheet of the invention is safely consumed by a mammal, preferably a human.

The edible paper-like sheet offers an alternate or substitute to a flatbread, seaweed-based paper, rice paper, and the like while retaining much of the nutritional value of the starting raw material. The edible paper-like sheet is useful for among other things wrapping around a multiplicity of foods, and can be used to provide wrapped foods. Alternatively, the edible paper-like sheet can be eaten as a paper.

### Method

The invention provides a method of making an edible paper-like sheet from an edible source including but not limited to a vegetable, root, and the like. In one embodiment, the edible source can be raw or cooked. In a preferred embodiment, the vegetable is kale. In one embodiment, the method seals in the color and nutritional value of the edible source.

In one embodiment, the edible source is washed. In one embodiment, the edible source is washed in water. After washing, the edible source is process according to the invention. For example, the washed edible source incubated in a solution comprising one or more of salt and whey.

In one embodiment, the method includes incubating the edible starting material with a mixture comprising salt for a period of time in order to generate an edible solution. In one embodiment, about one tablespoon of salt is used per about two quarts of water in order used to generate an edible solution. In some instances, about one tablespoon of salt is used per about one to three quarts of water to generate an edible solution. In some instances, about one tablespoon of salt is used per about one to three quarts of water in order used to generate an edible solution.

In one embodiment, the method includes incubating the edible starting material with a mixture comprising salt and whey for a period of time in order to generate an edible solution. In one embodiment, about two table spoons of whey and about one tablespoon of salt is used per about two quarts of water in order used to generate an edible solution. In some instances, about two table spoons of whey and about one tablespoon of salt is used per about one to three quarts of water to generate an edible solution. In some instances, about two table spoons of whey and about one tablespoon of salt is used per about one to three quarts of water in order used to generate an edible solution.

In one embodiment, the starting material is incubated with the edible solution comprising one or more of salt and whey at room temperature (e.g., from about 65° F. to 95° F.) for about 1 to 3 days. A skilled artisan would appreciate based on the present disclosure that the length of time depends on the temperature, wherein a lower temperature would require a longer length of time.

Whey is the residual liquid obtained after extracting proteins and fat from milk. Two categories of whey are distinguishable according to its acidity, derived from the manufacture of cooked or uncooked pressed cheese and acid whey, derived from other cheeses obtained by mixed or lactic coagulation (soft cheeses). The average composition of sweet whey is, as a guide, for 61 g of dry matter per kg of whey, from 42 g to 48 g of lactose, 8 g of proteins, 2 g of fat, 5 g to 7 g of minerals, 1 g to 5 g of lactic acid and the remainder as minerals and vitamins.

Proteins contained in whey, which are soluble proteins including lactoferrin, lactoperoxidase, immunoglobulins, albumin, α-lactalbumin, and β-lactoglobulin, are historically referred to as whey proteins.

The edible solution from the incubation of the starting edible material with a mixture comprising one or more of salt and whey is processed in to a puree or slurry, preferably a homogenous solution (e.g., casting solution) whereby the solution can be casted into a desirable shape. In one embodiment, the desired shape is a thin sheet. In one embodiment, the thin sheet is a paper-like sheet.

In one embodiment, the homogenous solution prior to casting has a slurry or paste-like texture to allow the formation of a sheet.

Any casting technique as known in the art may be used to form the desired shape of the edible paper-like sheet of the invention. In one embodiment, the casting solution is applied to a suitable carrier substrate (e.g., container) whereby water can be removed from the casting solution. Removal of water from the casting solution forms a paper-like sheet. In one embodiment, the suitable carrier substrate is a drainage board.

In one embodiment, the casting solution is poured into a substantially flat surface container to form a relatively thin sheet. The size of the container should be adjusted to form a sheet of desirable thickness. Prior to pouring the solution into the container, the container may be optionally coated with a non-sticky edible material such as food grade oil to prevent the resulting sheet from sticking to the pan.

In one embodiment, water is removed from the casting solution by evaporation. In one embodiment, water is removed from the casting solution by applying heat to the solution. In one embodiment, water is removed from the casting solution by applying wind to the solution. In one embodiment, water is removed from the casting solution by adding additional light to the solution.

Drying may be carried out as needed to obtain the desired dryness by procedures known in the art, including heating in a tunnel oven, dehydrator and the like. Additional drying steps may be carried out as desired. Infrared drying may be used to augment the hot air impingement drying process.

The solution is dried in the container, forming an edible sheet. The solution may dry by natural evaporation, preferably in an environment having warm, dry air. After the solution is dry and a relatively strong, paper-thin sheet is formed, the exposed side of the sheet may be optionally lightly coated with a food grade oil. Since the container may also have been coated with food grade vegetable oil, both sides of the sheet may have been coated with the food grade oil. The coatings of oil enhance the moisture barrier and help to preserve the integrity of the sheet when it comes in contact with other materials. Alternatively, other edible sheets having enhanced moisture impermeability properties may be used. The sheet is cut into useable sizes for wrapping desired food products.

In one embodiment, the suitable carrier is one that is substantially impermeable to the edible polymer layer, allows the casting solution to disperse substantially evenly onto the substrate and allows for easy removal of the edible layer from the substrate. The edible layer is then dried to form a sheet. The thickness of the dried edible sheet layer is generally in the range of about 0.004 inches to about 0.025 inches.

The over-all quality of the edible paper-like sheet of the invention is determined by various properties. Relevant properties in include:

Folding: a low tendency to break upon folding the edible paper-like sheet is desired.

Breaking: it is desired that the edible paper-like sheet shows good resistance against tearing.

Rolling: a desired edible paper-like sheet should be rollable, e.g. around a known diameter dowel, rod or stick, without showing substantial cracking and/or breaking. In particular it is desired to provide an edible paper-like sheet with good rolling properties for a prolonged period of time.

Color: a product with a substantially uniform color.

Dryness: an edible paper-like sheet should preferably dry similar to a piece of dry nori.

Stacking stickiness: It is desired that—when stacked and packaged—the edible paper-like sheets show no or a low tendency to stick to one another. In particular, upon aging the tendency to stick may increase.

### Composition

The edible paper of the invention is useful among other things for wrapping around foods to provide a wide range of convenient, nutritious, tasty foods, including handheld foods and snack foods. The edible paper can be used to wrap a multiplicity of foods. The edible paper can also be applied between foods. The edible paper can add additional appeal to a product by added nutrition, flavor, color, and novelty. In this way, the edible paper of the invention provides products which are healthy, convenient, flavorful, colorful, have ready-to-eat convenience, and provide interesting tastes and textures. The products may be prepared for immediate consumption or for future consumption. If for future consumption, it is preferred that the products be wrapped so as to maintain the dry, textured properties of the edible paper of the invention

In one embodiment, the edible paper has the flavor of the edible material from which the paper is generated from. However, the edible paper of the invention can also have a neutral flavor.

In one embodiment, the edible paper maintains the color of the starting edible material. In one embodiment, the edible paper can be modified to have any color desired by using a natural source of coloring. Alternatively, the edible paper can be modified to have a desired color using a food dye.

In one embodiment, the edible paper maintains a significant nutritional value of the starting edible material. In one embodiment, additional nutrients can be added to supplement the natural nutritional value of the starting edible material.

In one embodiment, the edible paper is made from an edible material including but is not limited to vegetable, root, and the like. In one embodiment, the edible paper maintains the color and nutritional value of the starting edible material.

Non-limiting examples of vegetables that can be used include but are not limited to green vegetable, swiss chard, kale, collards, carrot, tomato, broccoli, bell pepper, pumpkin, pumpkin, squash, corn, sweet potato, spinach, green bean, green pea, asparagus, alfalfa, and the like. The vegetable component in the paper may comprise one type of vegetable alone or two or more types of vegetables.

In any of these aspects, the edible paper can have a composition that is substantially or entirely consisting of vegetable material. Particularly, the edible paper can have a composition that includes at least 50% vegetable material, or at least 60% vegetable material, or at least 70% vegetable material, or at least 80% vegetable material, or at least 90% vegetable material, or consist entirely of vegetable material.

Non-limiting examples of root that can be used include but are not limited to taro, turnip, beets, kolrobi, radish, celery root, and the like. The root component in the paper may comprise one type of root alone or two or more types of roots.

In any of these aspects, the edible product can have a composition that is substantially or entirely consisting of root material. Particularly, the edible product can have a composition that includes at least 50% root material, or at least 60% root material, or at least 70% root material, or at least 80% root material, or at least 90% root material, or consist entirely of root material.

In one embodiment, the edible paper is made from one or more of vegetable and root.

In one embodiment, the edible paper of the invention is used as a wrapper. For example, the edible paper of the invention can be used to wrap any desired food. Accordingly an object of the present invention is to provide an edible food wrap for a variety of comestibles. Yet another object of the invention is to provide an edible food wrap for the efficient, economical, and aesthetically attractive preparation of individual consumer portions. For example, the edible paper of the invention can be used is a similar manner as rice paper or nori to wrap a desired filling.

Generally, the color of the edible paper of the invention takes the color from the starting edible source. However, for those applications where a noticeably colored food wrap is required, a coloring agent is added to the materials during the process of making the edible paper. Depending on preferences, the coloring agent can be selected from FDA approved agents. However, from a purist point of view only naturally occurring coloring substances should be used. In this latter case materials such as red colored beets or yellow colored beets can be used as a source of coloring.

In one embodiment, the edible paper of the invention is used as a baking sheet liner. For example, while making cupcakes, edible paper of the invention is used as a lining material in order to prevent the batter from sticking to the pans during baking. As against an ordinary liner paper, if the edible paper of the invention is used, one can eat the whole piece even without peeling off the paper cup.

In one embodiment, the edible paper of the invention can be used as a food decoration including but is not limited to cake decoration. For example a cake can be decorated with objects made out of the edible paper of the invention. A sheet of edible paper can be cut into any shape like flowers, trees, numbers, letter, animals etc. A food-coloring pen can be used to color the shaped paper.

In one embodiment, the edible paper of the invention can be used as a canvas for a digital image. For example, scenery, pictures or photographs can be printed using latest technology with edible ink on the edible paper of the invention. The printed sheet is then embedded on the cake, for example, to provide an additional decorative piece.

In one embodiment, the edible paper of the invention is easily printed, cut and handled. Specifically, the present invention can be used to reproduce sharp, clear designs and images to use as decorations for food, without detracting from the edibility or the taste appeal of the food itself. Furthermore, the edible paper of the present invention is relatively stable, so that decorations can be prepared in advance of the actual time of serving of the decorated food.

In one embodiment, the edible paper of the invention is a thin sheet made of food ingredients which can be consumed without harsh effects on the normal human digestive system. Because thin sheets of edible paper are made from food ingredients, edible paper is suitable to be eaten along with any desirable foods.

The edible paper of the present invention is edible and easily digestible. The paper can be formulated with various ingredients to impart a unique, attractive taste or aroma depending on the preference of the consumer. In addition, other vitamins, minerals, etc. can be added for maintaining health and vitality of the consumer.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

The following examples further illustrate aspects of the present invention. However, they are in no way a limitation of the teachings or disclosure of the present invention as set forth herein.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the compounds of the present invention and practice the claimed methods. The following working examples therefore, specifically point out the preferred embodiments of the present invention, and are not to be construed as limiting in any way the remainder of the disclosure.

### Example 1

### Vegetable Paper Production Method to Make Vegetable Paper while Retaining Much of the Nutritional Value and Color of the Vegetable

The edible paper-like sheet can be made by the following steps. Take a green vegetable (e.g., Swiss Chard or Kale; 1 bunch) and place it in a jar. Add water (2 quarts), salt (1 table spoon) and fresh whey (2 table spoons). Close jar lid and let sit for five days at 70° Fahrenheit. Remove contents from the jar and preferably rinse and place it in a blender to make a slurry. Slurry is placed on a drainage board as a layer and set to dry. A paper-like sheet is formed after the drying process.

In a preferred embodiment, it is desirable to use leaf and not the stem for the process. However, some stem is not detrimental to the process.

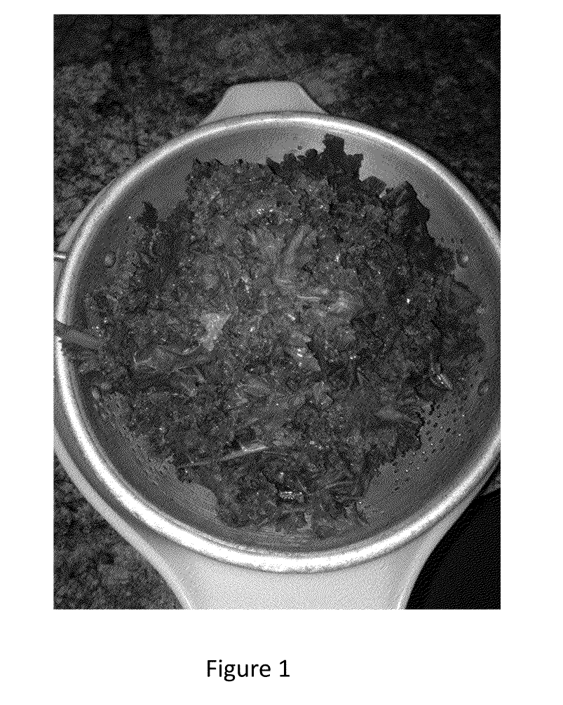

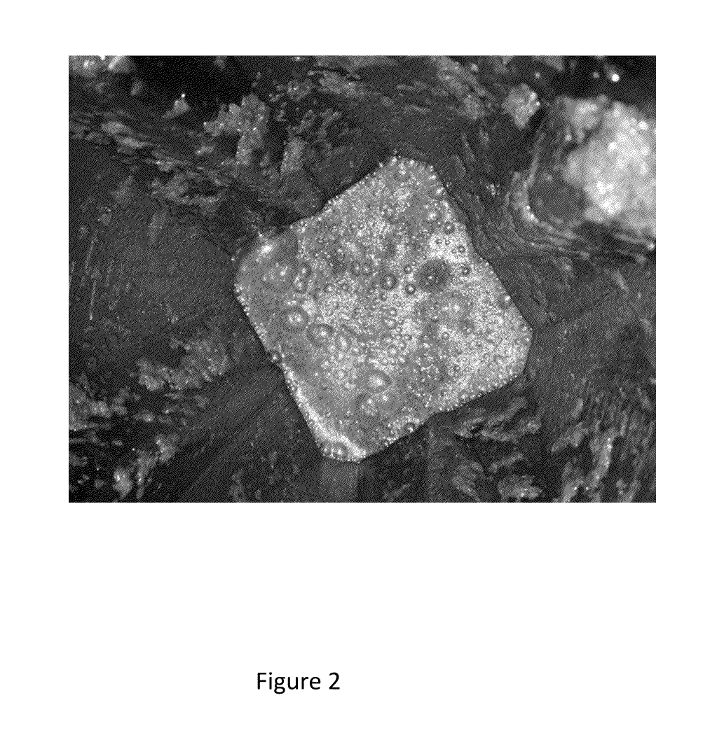

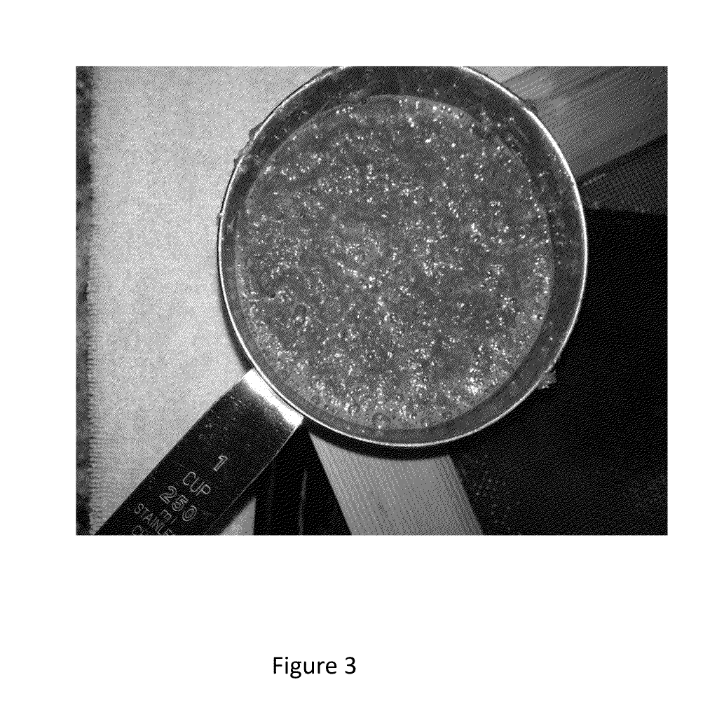

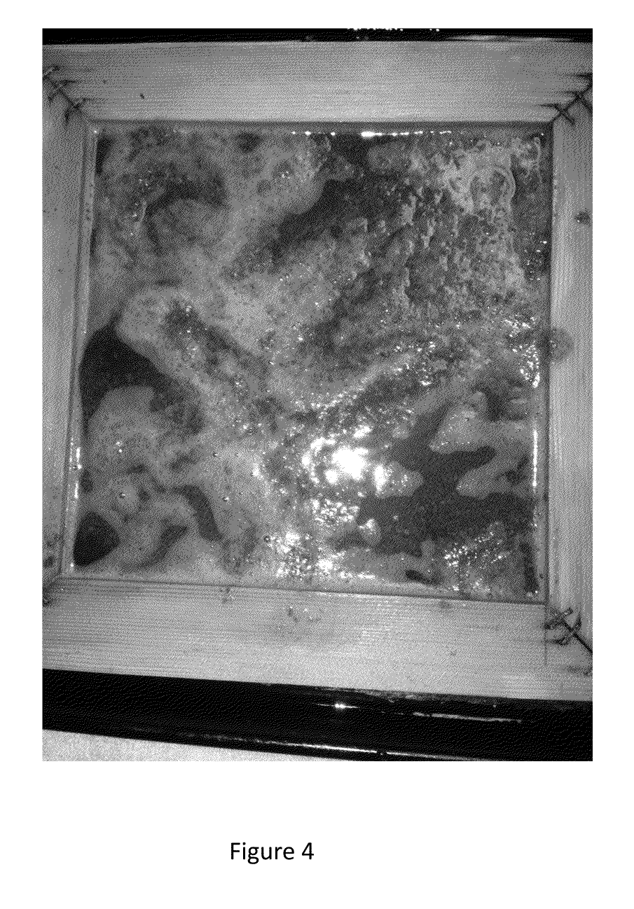

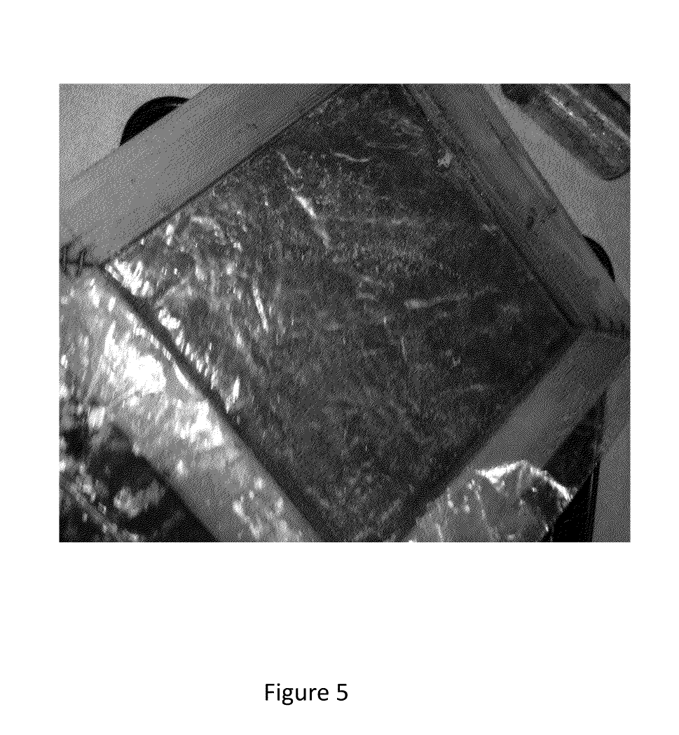

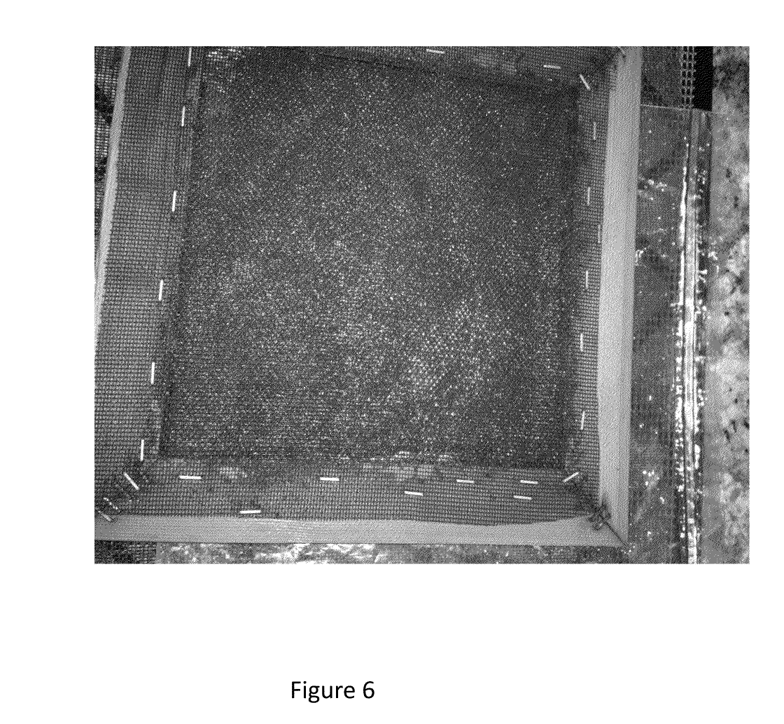

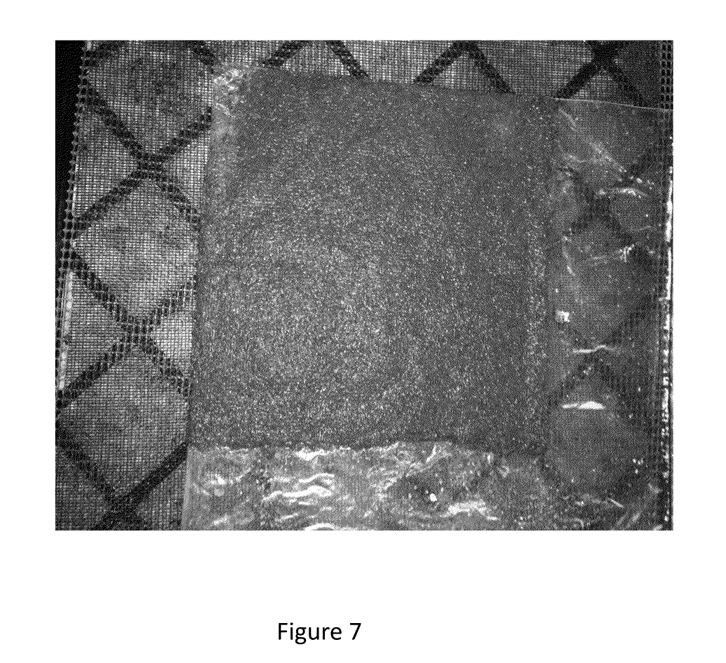

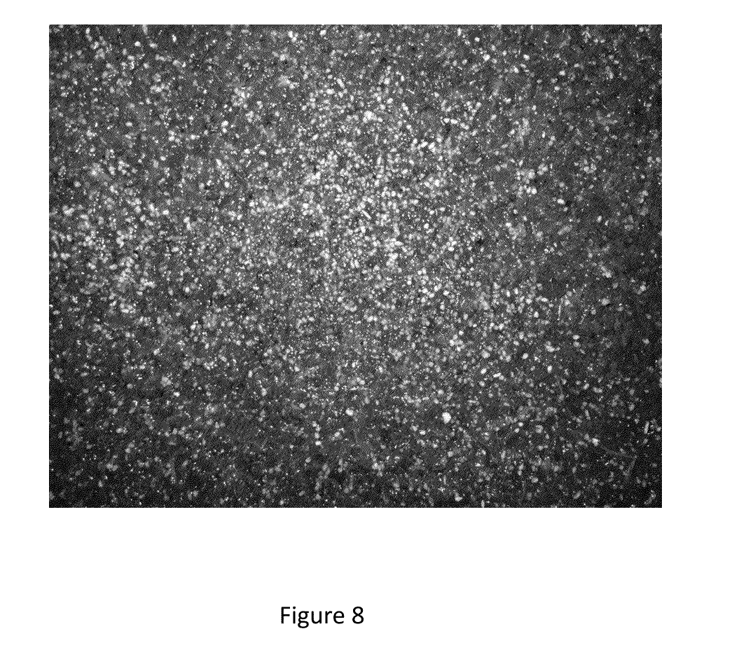

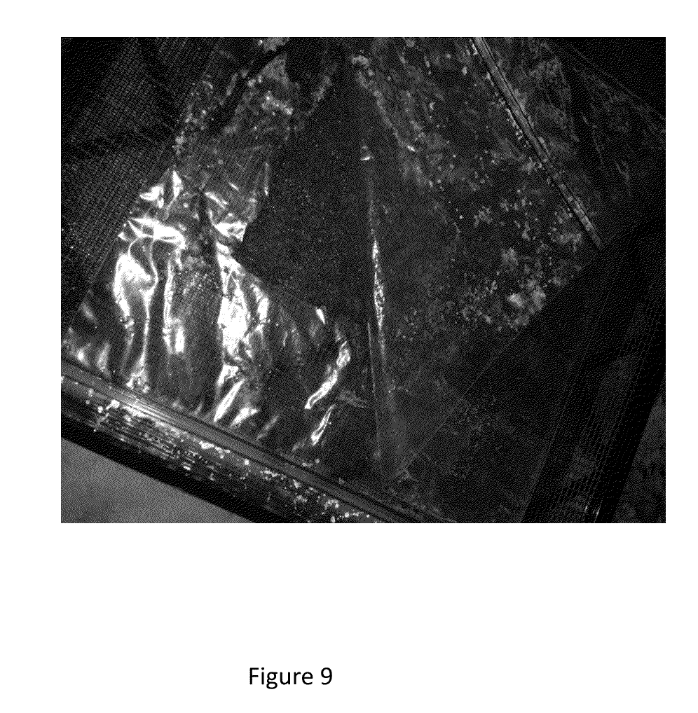

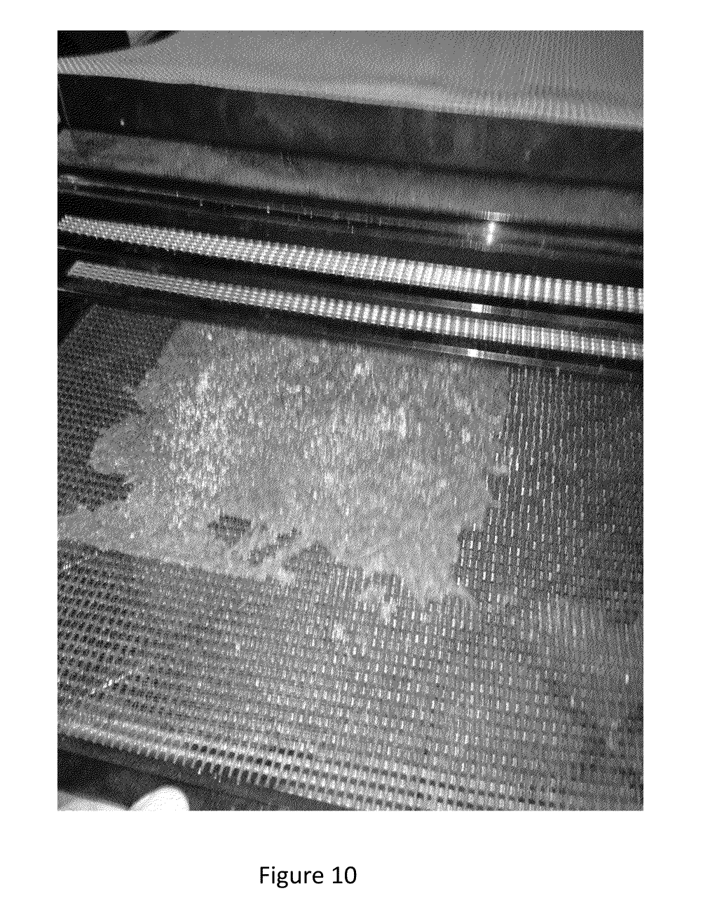

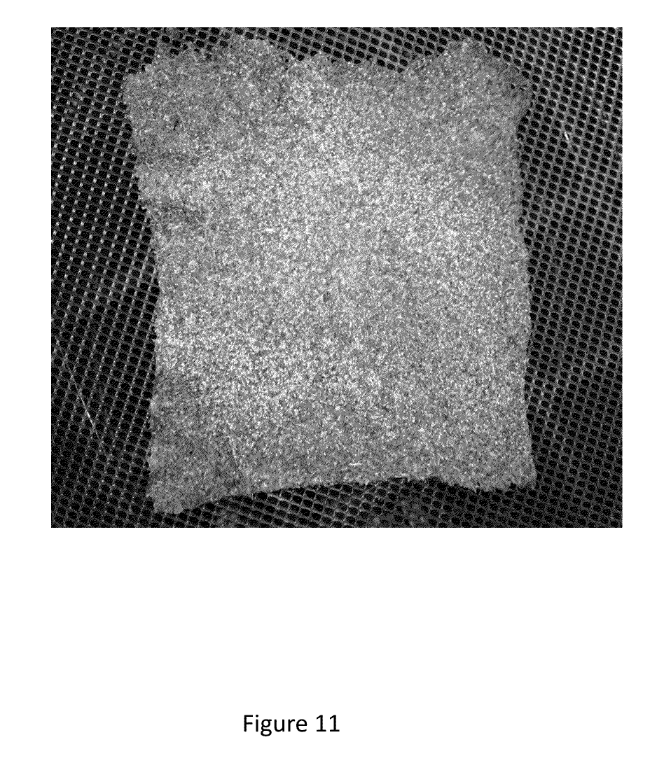

An exemplary process is depicted in FIGS. 1-11. For example, the starting material is washed. In some instances, the starting material is bathe in a desirable solution. The starting material is then grounded up, preferably in a blender and the slurry therefrom is placed on a screen as a sheet-like paper to dry. In some instances, additional spices can be added to the sheet-like paper prior to, during, or after the drying process. The sheet-like paper is placed into a dryer to fully dry the sheet-like paper to produce the final product of an edible paper-like sheet that resembles nori.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A method for making an edible paper-like sheet, the method comprising:
(a) incubating an edible starting material with a mixture comprising water, salt, and whey for a period of time to generate an edible solution;
(b) processing the edible solution to generate a casting solution;
(c) applying the casting solution to a container to produce a sheet;
(d) drying the sheet to produce an edible paper-like sheet.

2. The method of claim 1, wherein the edible starting material is selection from the group consisting of a vegetable, a root, and any combination thereof.

3. The method of claim 2, wherein the vegetable is selected from the group consisting of green vegetable, swiss chard, kale, collards, carrot, tomato, broccoli, bell pepper, pumpkin, pumpkin, squash, corn, sweet potato, spinach, green bean, green pea, asparagus, alfalfa, and any combination thereof.

4. The method of claim 2, wherein the root is selected from the group consisting of taro, turnip, beets, kolrobi, radish, celery root, and the like.

5. The method of claim 1, wherein the period of time is about 1-5 days.

6. The method of claim 1, wherein the period of time is less than about 1 day.

7. The method of claim 1, wherein the edible starting material is incubated with a mixture comprising water, salt, and whey at a temperature of about 65 degrees Fahrenheit.

8. The method of claim 1, wherein the edible starting material is incubated with a mixture comprising water and salt at a temperature of about 65 degrees Fahrenheit.

9. An edible paper-like sheet produced by the method of claim 1.

10. The edible paper-like sheet of claim 9, having a thinkness of about 0.004 to 0.025 of an inch.
